(19) United States
(12) Patent Application Publication
(10) Pub. No.: US 2006/0132679 A1
(43) Pub. Date: Jun. 22, 2006

(54) Liquid crystal display with high color gamut

(75) Inventors: Shou-Ling Sui, Taoyuan Hsien (TW); Sheng-Wen Cheng, Chang Hua City (TW)

Correspondence Address: BIRCH STEWART KOLASCH & BIRCH, PO BOX 747, FALLS CHURCH, VA, 22040-0747, US

(73) Assignee: AU Optronics Corp.

(21) Appl. No.: 11/303,932

(22) Filed: Dec. 19, 2005

(30) Foreign Application Priority Data
Dec. 20, 2004 (TW) 93139647

(51) Int. Cl. G02F 1/1335

(52) U.S. Cl. 349/106

(57) ABSTRACT

A LCD comprises a color filter and a backlight source. The color filter has a plurality of green filter units having transmittance ranging from about 0.1% to about 60% at an optical wavelength of 500nm, and a plurality of blue filter units having transmittance ranging from about 0.1% to about 50% at the optical wavelength of 500nm. The backlight source comprises a first phosphor with a first peak emission wavelength between 440nm and 460nm, a second phosphor with a second peak emission wavelength between 540nm and 550nm, and a third phosphor with third peak emission wavelength between 500nm and 530nm. The intensity ratio of the second peak emission wavelength to the first peak emission wavelength ranges from 0 to about 3.6, and the intensity ratio of the third peak emission wavelength to the first peak emission wavelength ranges from about 0.8 to about 2.7.

### BACKGROUND OF THE INVENTION

(1) Field of the Invention

The present invention relates to a display, and more particularly to a liquid crystal display with high color gamut.

(2) Description of the Prior Art

In the past, the liquid crystal display (LCD) is applied to a wide variety of items, such as personal computer (PC), television (TV), mobile navigation system, cell phone, and personal digital assistant (PDA).

A LCD have a backlight source and a liquid crystal panel. The liquid crystal panel comprises an array of pixels for respectively adjusting light transmittance from the backlight source so as to control gray levels of each pixel. The liquid crystal panel comprises a color filter including a plurality of blue filter units, a plurality of green filter units, and a plurality of red filter units. Through this color filter, the LCD is able to display color pictures.

From the liquid crystal panel point of view, the display quality aims for high definition, high luminance, a wide color reproducible range. For current technology, the high definition and high luminance is substantially able to meet the high standard, so as to satisfy the market and the consumer. However, the reproducible range of colors is still not wide enough. This results in several drawbacks, such as color distortion, color shifting or insufficient color saturation.

Please refer to FIG. 1. FIG. 1 is a CIE chromaticity diagram relating to prior art. A NTSC color reproducible region 10, which is enclosed by a black triangle, approximately represents the gamut of color that according to a standard of the National Television Systems Committee (NTSC). And a display color reproducible region 12, which is enclosed by another triangle, represents the gamut of color that are possible to be displayed on a conventional LCD. In this art, a “NTSC ratio” means a ratio of the area of the display color reproducible region 12 over the NTSC color reproducible region 10. To expand the display color reproducible region 12 so as to make the NTSC ratio achieve 100%, or even higher, is desired in the LCD industry and related arts. However, in most prior arts, the NTSC ratio of a desktop LCD or a LCD television is limited to about 75%. And it is even worse for the LCD of a laptop computer, its NTSC ratio is limited to about only 45%.

Please refer to FIG. 2. FIG. 2 is a graph showing both the emission spectrum of a prior backlight source and the spectral transmittance of a prior color filter. As shown in FIG. 2, the x axis indicates an optical wavelength. The y axis on the left indicates transmittance of the color filter. The y axis on the right indicates energy ratio of the emission spectrum. Transmittance spectrums of a blue filter unit, a green filter unit, and a red filter unit are respectively indicated by reference numerals 100B, 100G, and 100R. Taking the blue transmittance spectrum 100B for example, the blue filter unit has a maximum transmittance at about 450 nm. Therefore, while white lights, from the backlight source, is transmitted through the blue filter unit, only blue lights within a wavelength region around the peak emission wavelength about 500 nm are allowed to pass, light out of this wavelength region are filtered.

However, white light is a composition of various color lights. The white light provided by the prior backlight source has different intensity at each wavelength. The prior backlight source usually comprises a fluorescent tube or cold cathode fluorescent lamp (CCFL). As shown in FIG. 2, blue emission spectrum 1001, green emission spectrum 1002 and red emission spectrum 1004 respectively indicates lights generated by a blue phosphor, a green phosphor and a red phosphor within a prior cold cathode fluorescent tube. In addition, typically, the cold cathode fluorescent tube of the prior backlight source further comprises a blue-green phosphor having an blue-green emission spectrum 1003 having a peak between the peak of the blue emission spectrum 1001 and the green emission spectrum 1002.

The above-mentioned drawbacks of the prior art, such as color distortion or insufficient saturation are resulted from both of the backlight source and the color filter.

### SUMMARY OF The INVENTION

The primary objective of the present invention is to provide a color reproducible region of a LCD that corresponds to a standard of National Television Systems Committee (NTSC).

Another objective of the present invention is to improve the drawback of color distortion of the prior LCD.

Another objective of the present invention is to improve the drawback of insufficient saturation of a LCD of the prior art.

A LCD comprising a color filter and a backlight source is provided. The color filter comprises a plurality of green filter units and a plurality of blue filter units the green filter units has transmittance ranging from about 0.1% to about 60% at the optical wavelength of about 500 nm. The blue filter units has transmittance ranging from about 0.1% to about 50% at the optical wavelength of about 500 nm. The backlight source has a first phosphor with a first peak emission wavelength between 440 nm and 460 nm, a second phosphor with a second peak emission wavelength between 540 nm and 550 nm, and a third phosphor with a third peak emission wavelength between 500 nm and 530 nm. The intensity ratio of the second peak emission wavelength to the first peak emission wavelength ranges from 0 to 3.6, and the intensity ratio of the third peak emission wavelength to the first peak emission wavelength ranges from 0.8 to 2.7.

These and other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

The present invention will now be specified with reference to its preferred embodiment illustrated in the drawings, in which

FIG. 1 is a CIE chromaticity diagram relating to prior art.

FIG. 2 is a graph showing both the emission spectrum of a prior backlight source and the spectral transmittance of a prior color filter.

FIG. 3 is an exploded view of a liquid crystal display(LCD) according to the present invention.

FIG. 4A is a CIE chromaticity diagram relating to a present embodiment.

FIG. 4B is a graph showing both the emission spectrum of a present backlight source and the spectral transmittance according to a present embodiment.

FIG. 5A is a CIE chromaticity diagram relating to another present embodiment.

FIG. 5B is a graph showing both the emission spectrum of a present backlight source and the spectral transmittance according to another present embodiment.

FIG. 6A is a CIE chromaticity diagram relating to another present embodiment.

FIG. 6B is a graph showing both the emission spectrum of a present backlight source and the spectral transmittance according to another present embodiment.

FIG. 7A is a CIE chromaticity diagram relating to another present embodiment.

FIG. 7B is a graph showing both the emission spectrum of a present backlight source and the spectral transmittance according to another present embodiment.

FIG. 8A is a CIE chromaticity diagram relating to another present embodiment.

FIG. 8B is a graph showing both the emission spectrum of a present backlight source and the spectral transmittance according to another present embodiment.

FIG. 9A is a CIE chromaticity diagram relating to another present embodiment.

FIG. 9B is a graph showing both the emission spectrum of a present backlight source and the spectral transmittance according to another present embodiment.

FIG. 10A is a CIE chromaticity diagram relating to another present embodiment.

FIG. 10B is a graph showing both the emission spectrum of a present backlight source and the spectral transmittance according to another present embodiment.

FIG. 11A is a CIE chromaticity diagram relating to another present embodiment.

FIG. 11B is a graph showing both the emission spectrum of a present backlight source and the spectral transmittance according to another present embodiment.

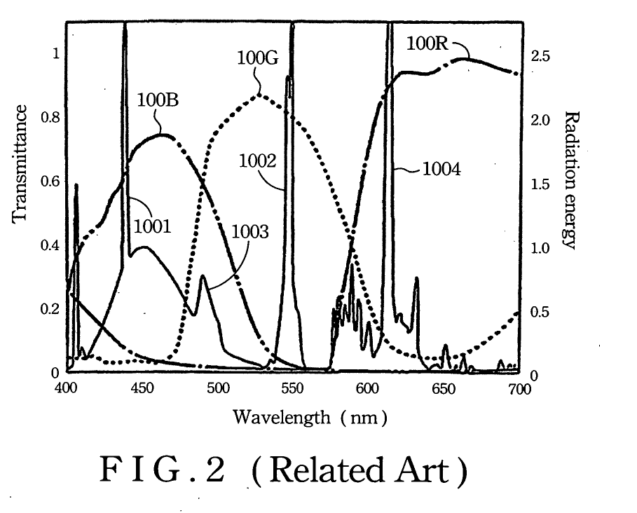

### DESCRIPTION OF THE PREFERRED EMBODIMENT

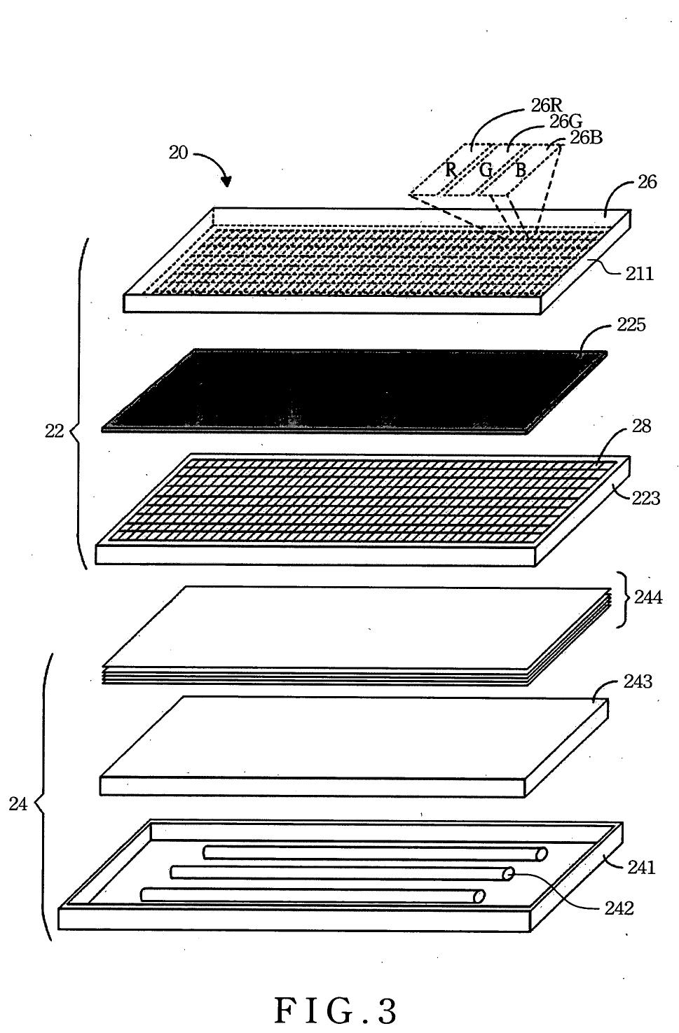

Please refer to FIG. 3. FIG. 3 is an exploded view of a liquid crystal display(LCD) according to the present invention. The LCD 20 comprises a liquid crystal panel 22 and a backlight source 24. The liquid crystal panel 22 have an upper substrate 221, a lower substrate 223, and a liquid crystal layer 225. The liquid crystal layer 225 is disposed in between the upper substrate 221 and the lower substrate 223.

An array of thin film transistors, disposed on the lower substrate 223, is capable of adjusting transmittance of light, which is from the backlight source 24, by controlling rotation angles of liquid crystal molecule. Therefore, gray levels, which are needed to construct individual frame of pictures, are able to be presented.

The liquid crystal panel 22 further comprise a color filter 26 disposed on a bottom surface of the upper substrate 221. The color filter 26 has a plurality of blue filter units 26B, a plurality of green filter units 26G, and a plurality of red filter units 26R.

Through combined the color filter 26 of the upper substrate 221 and the liquid crystal layer 225 controlled by the array of thin film transistors of the lower substrate 223, the LCD 20 is able to display continuous frames of color picture.

In practice, a direct type backlight shown in FIG. 3 serves as the backlight source 24 in this embodiment. However, the direct type backlight should not be the limit of the present invention, other types of backlight, such as a side-edge type backlight, can also be adopted for the present invention. As shown in FIG. 3, the backlight source 24 comprises a reflecting sheet 241, at least a light tube 242, a diffusion plate 243, and a plurality of optical thin films 244. The light tube 242, such as a fluorescent tube or a cold cathode fluorescent lamp (CCFL), comprises a plurality of phosphors within.

One remarkable achievement of the present invention is that the color reproducible region of the present LCD 20 is enlarged so as to achieve about 100% NTSC ratio, or even higher. The means of the present invention is substantially about to control individual intensity of the primary color lights from the backlight source 24, mean while, to control individual transmittance of the filter units of the color filter 26.

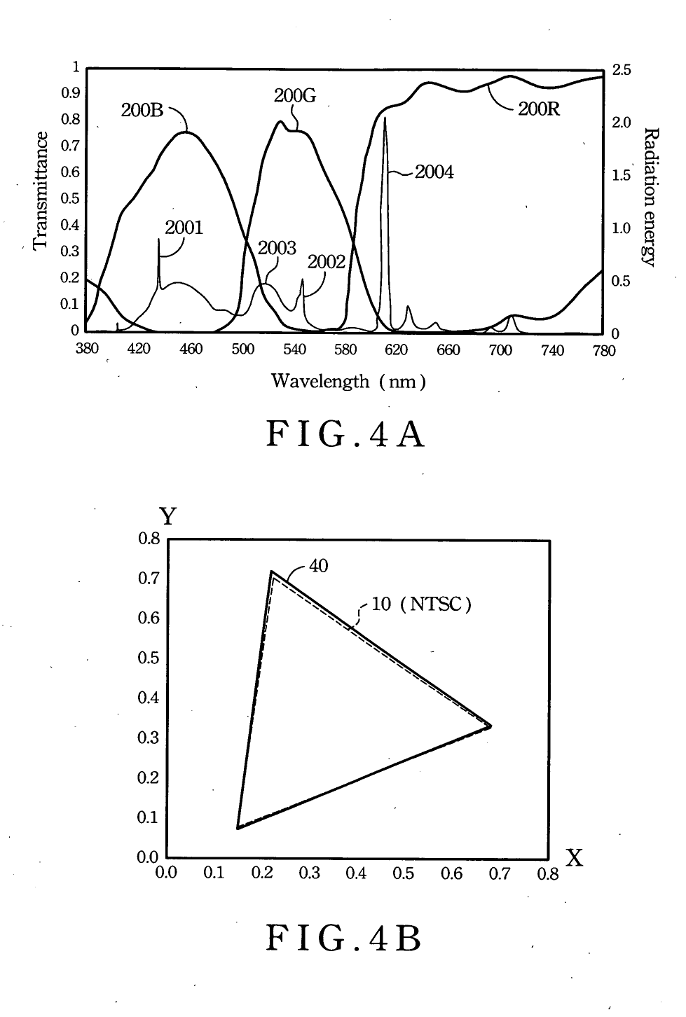

Please refer to FIG. 4A and FIG. 4B. FIG. 4A is a CIE chromaticity diagram relating to the present invention. FIG. 4B is a graph showing both the emission spectrum of a present backlight source and the spectral transmittance of a present color filter. A NTSC color reproducible region 10, which is enclosed by a dotted-line triangle, approximately represents the gamut of color that according to a standard of the National Television Systems Committee (NTSC). And a display color reproducible region 40, which is enclosed by a black-line triangle, represents the gamut of color that are possible to be displayed on the present LCD 20.

As mentioned above, the color filter 26 has the plurality of green filter units 26G, the plurality of blue filter units 26B, and the plurality of red filter units 26R. A blue transmittance spectrum 200B, a green transmittance spectrum 200G and a red transmittance spectrum 200R respectively corresponds to the blue filter units 26B, the green filter units 26G and the red filter units 26R, in order. In the present invention, at an optical wavelength of about 500 nm, the color filter 26 has to meet the following two conditions:
a) the green filter units 26G (the green transmittance spectrum 200G) have transmittance ranging from about 0.1% to about 60% at optical wavelength of 500 nm; and
b) the blue filter units 26B (the blue transmittance spectrum 200B) have transmittance ranging from about 0.1% to about 50% at an optical wavelength of 500 nm.

In another aspect, phosphors within the light tube 242 also have a noteworthy effect on the display color reproducible region 40 of the present LCD 20. Generally, the backlight source may comprises a first phosphor, a second phosphor, a third phosphor and a fourth phosphor, within the light tube 242. The first phosphor generates light with a first peak emission wavelength 2001 between 440 nm and 460 nm substantially belonging to blue. The second phosphor generates light with a second peak emission wavelength 2002 between 540 nm and 550 nm substantially belonging to green. The third phosphor generates light with a third peak emission wavelength 2003 between 500 nm and 530 nm substantially belonging to blue-green. The fourth phosphor generates light with a fourth peak emission wavelength 2004 between 605 nm and 615 nm substantially belonging to red. However, the second phosphor (green) is optional and may be existing or not.

After repeated experiments, two conditions of the backlight source 24 have been established:
1) The intensity ratio of the second peak emission wavelength 2002 to the first peak emission wavelength 2001 ranges from 0 to about 3.6.
2) The intensity ratio of the third peak emission wavelength 2003 to the first peak emission wavelength 2001 ranges from about 0.8 to about 2.7.

While the color filter 26 meets the above-mentioned two conditions (a, b) at the optical wavelength of 500 nm, and the backlight source 24 meets its two conditions (1,2), the LCD 20 is able to present a wide display color reproducible region (as the black-line triangle indicated numeral 40 in FIG. 4B). In other words, the displayed color quality of the LCD 20 is thus promoted.

Please refer to FIG. 4A and FIG. 4B. For the first embodiment, at the optical wavelength of about 500 nm, the blue filter units 26B have transmittance (the blue transmittance spectrum 200B) of about 40%, and the green filter units 26G have transmittance (the green transmittance spectrum 200G) of about 25%. In addition, the intensity ratio of the second peak emission wavelength 2002 to the first peak emission wavelength 2001 is about 0.9, and the intensity ratio of the third peak emission wavelength 2003 to the first peak emission wavelength 2001 is about 0.95.

As shown in FIG. 4B, according to this embodiment, the display color reproducible region 40 of the LCD 20 achieves a NTSC ratio of about 100%. Therefore, the LCD 20 is able to display frames of picture with high sufficient color saturation. Besides, the display color reproducible region 40 of the present LCD 20 almost precisely overlaps the NTSC color reproducible region 10 on the CIE chromaticity diagram. The pure red, the pure green, and the pure blue of the display color reproducible region 40 are very close to their standard according to the NTSC specification respectively. Obviously, prior drawback of color distortion is overcome in this embodiment.

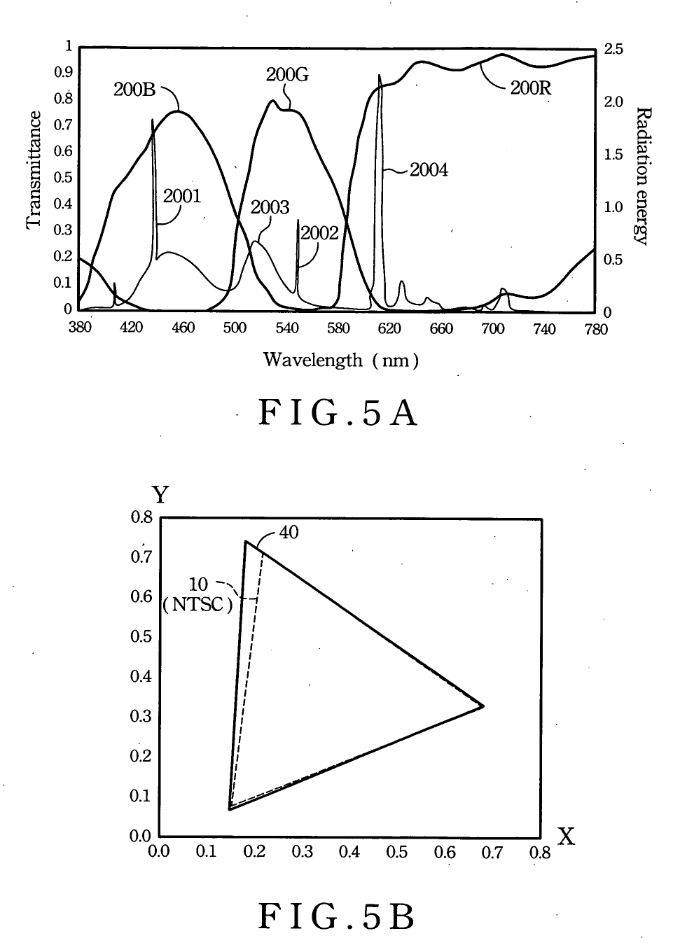

Please refer to FIG. 5A and FIG. 5B. FIG. 5A is a CIE chromaticity diagram relating to the present invention. FIG. 5B is a graph showing both the emission spectrum of a present backlight source and the spectral transmittance of a present color filter.

For the second embodiment, at the optical wavelength of about 500 nm, the blue filter units 26B have transmittance (the blue transmittance spectrum 200B) of about 33%, and the green filter units 26G have transmittance (the green transmittance spectrum 200G) of about 25%. In addition, the intensity ratio of the second peak emission wavelength 2002 to the first peak emission wavelength 2001 is 0. In other words, the second phosphor (green) does not exist in the light tube in this embodiment. The intensity ratio of the third peak emission wavelength 2003 to the first peak emission wavelength 2001 is about 1.24.

As shown in FIG. 5B, according to this embodiment, the NTSC ratio is higher than 100%. The display color reproducible region 40 of the present LCD 20 overlaps the whole NTSC color reproducible region 10 on the CIE chromaticity diagram. The pure red and the pure blue of the display color reproducible region 40 are very close to their standard according to the NTSC specification respectively. Only the pure green of the display color reproducible region 40 exceeds the NTSC standard. However, it does not cause color distortion.

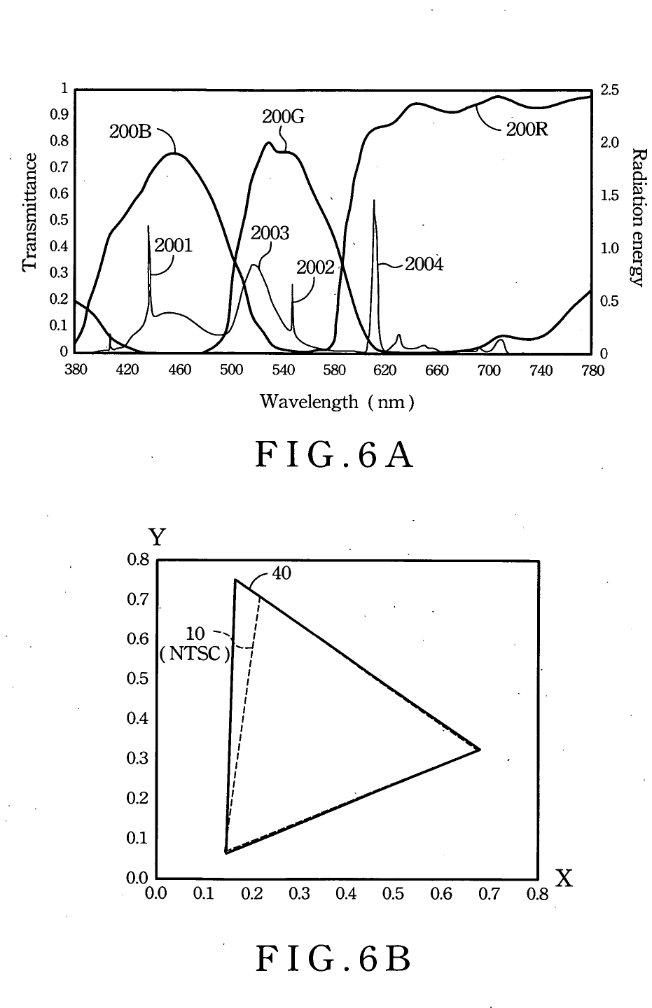

Please refer to FIG. 6A and FIG. 6B. FIG. 6A is a CIE chromaticity diagram relating to the present invention. FIG. 6B is a graph showing both the emission spectrum of a present backlight source and the spectral transmittance of a present color filter.

For the third embodiment, at the optical wavelength of 500 nm, the blue filter units 26B have transmittance (the blue transmittance spectrum 200B) of about 25%, and the green filter units 26G have transmittance (the green transmittance spectrum 200G) of about 25%. In addition, the intensity ratio of the second peak emission wavelength 2002 to the first peak emission wavelength 2001 is 0. In other words, the second phosphor (green) does not exist in the light tube in this embodiment. The intensity ratio of the third peak emission wavelength 2003 to the first peak emission wavelength 2001 is about 2.21.

As shown in FIG. 6B, according to this embodiment, the NTSC ratio is higher than 100%. The display color reproducible region 40 of the present LCD 20 overlaps the whole NTSC color reproducible region 10 on the CIE chromaticity diagram. Only the pure green of the display color reproducible region 40 exceeds the NTSC standard. However, it does not cause color distortion.

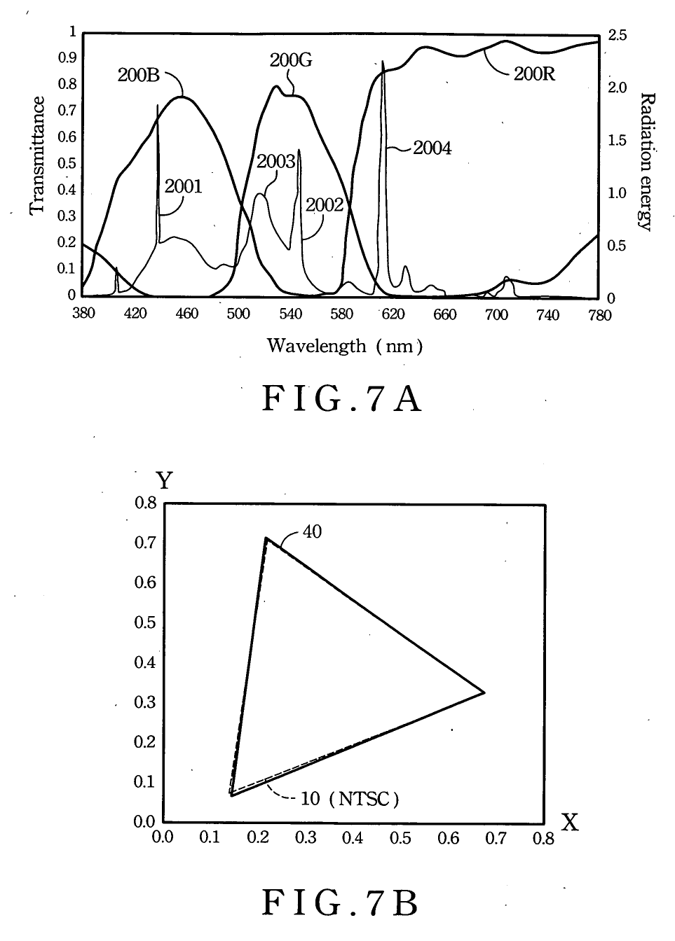

Please refer to FIG. 7A and FIG. 7B. FIG. 7A is a CIE chromaticity diagram relating to the present invention. FIG. 7B is a graph showing both the emission spectrum of a present backlight source and the spectral transmittance of a present color filter.

For the fourth embodiment, at the optical wavelength of 500 nm, the blue filter units 26B have transmittance (the blue transmittance spectrum 200B) of about 33%, and the green filter units 26G have transmittance (the green transmittance spectrum 200G) of about 33%. In addition, the intensity ratio of the second peak emission wavelength 2002 to the first peak emission wavelength 2001 is 1.23. The intensity ratio of the third peak emission wavelength 2003 to the first peak emission wavelength 2001 is about 1.60.

As shown in FIG. 7B, according to this embodiment, the NTSC ratio is close to 100%. The display color reproducible region 40 of the present LCD 20 almost fits the location and the shape of the NTSC color reproducible region 10 on the CIE chromaticity diagram.

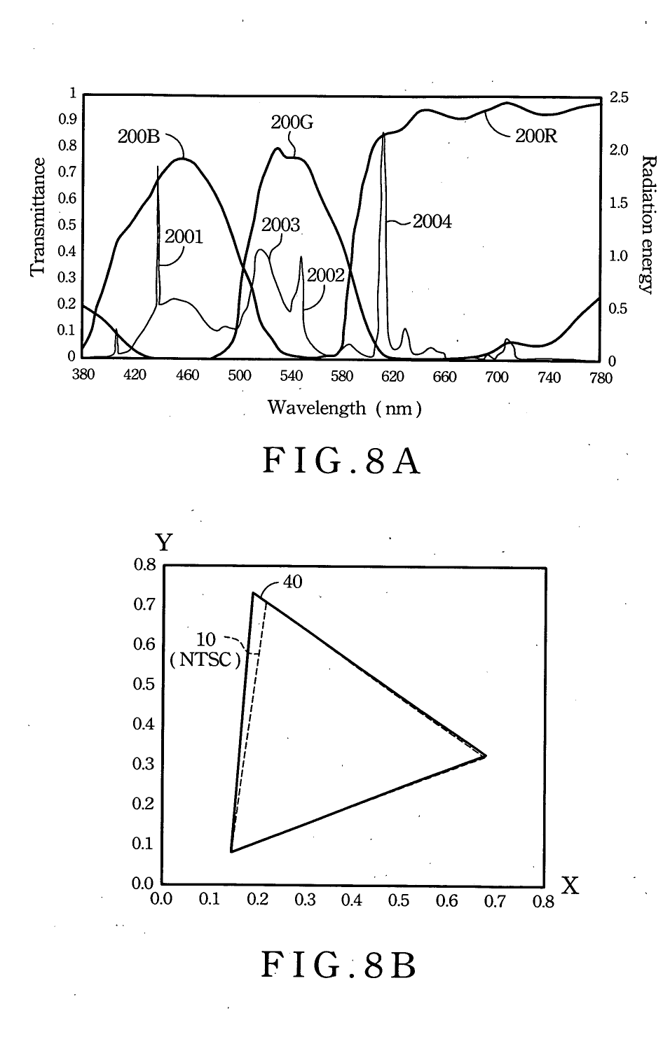

Please refer to FIG. 8A and FIG. 8B. FIG. 8A is a CIE chromaticity diagram relating to the present invention. FIG. 8B is a graph showing both the emission spectrum of a present backlight source and the spectral transmittance of a present color filter.

For the fifth embodiment, at the optical wavelength of 500 nm, the blue filter units 26B have transmittance (the blue transmittance spectrum 200B) of about 25%, and the green filter units 26G have transmittance (the green transmittance spectrum 200G) of about 35%. In addition, the intensity ratio of the second peak emission wavelength 2002 to the first peak emission wavelength 2001 is 2.19. The intensity ratio of the third peak emission wavelength 2003 to the first peak emission wavelength 2001 is about 1.69.

As shown in FIG. 8B, according to this embodiment, the NTSC ratio is higher than 100%. The display color reproducible region 40 of the present LCD 20 overlaps the whole NTSC color reproducible region 10 on the CIE chromaticity diagram. Only the pure green of the display color reproducible region 40 exceeds the NTSC standard. However, it does not cause color distortion.

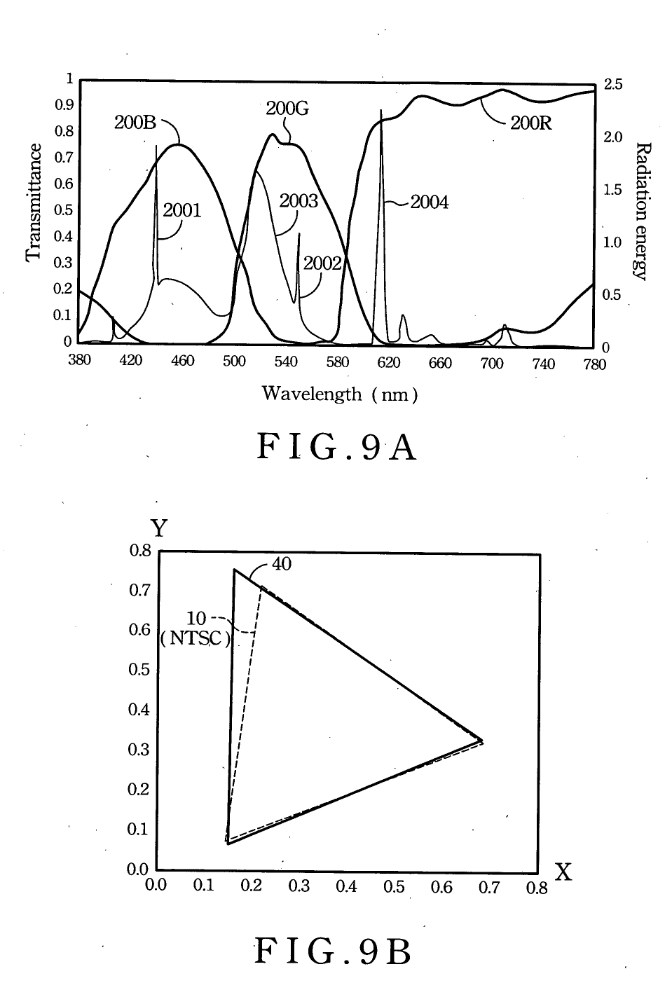

Please refer to FIG. 9A and FIG. 9B. FIG. 9A is a CIE chromaticity diagram relating to the present invention. FIG. 9B is a graph showing both the emission spectrum of a present backlight source and the spectral transmittance of a present color filter.

For the sixth embodiment, at the optical wavelength of 500 nm, the blue filter units 26B have transmittance (the blue transmittance spectrum 200B) of about 20%, and the green filter units 26G have transmittance (the green transmittance spectrum 200G) of about 33%. In addition, the intensity ratio of the second peak emission wavelength 2002 to the first peak emission wavelength 2001 is close to 0. The intensity ratio of the third peak emission wavelength 2003 to the first peak emission wavelength 2001 is about 2.31.

As shown in FIG. 9B, according to this embodiment, the NTSC ratio is higher than 100%. The display color reproducible region 40 of the present LCD 20 overlaps the whole NTSC color reproducible region 10 on the CIE chromaticity diagram. Only the pure green of the display color reproducible region 40 exceeds the NTSC standard. However, it does not cause color distortion.

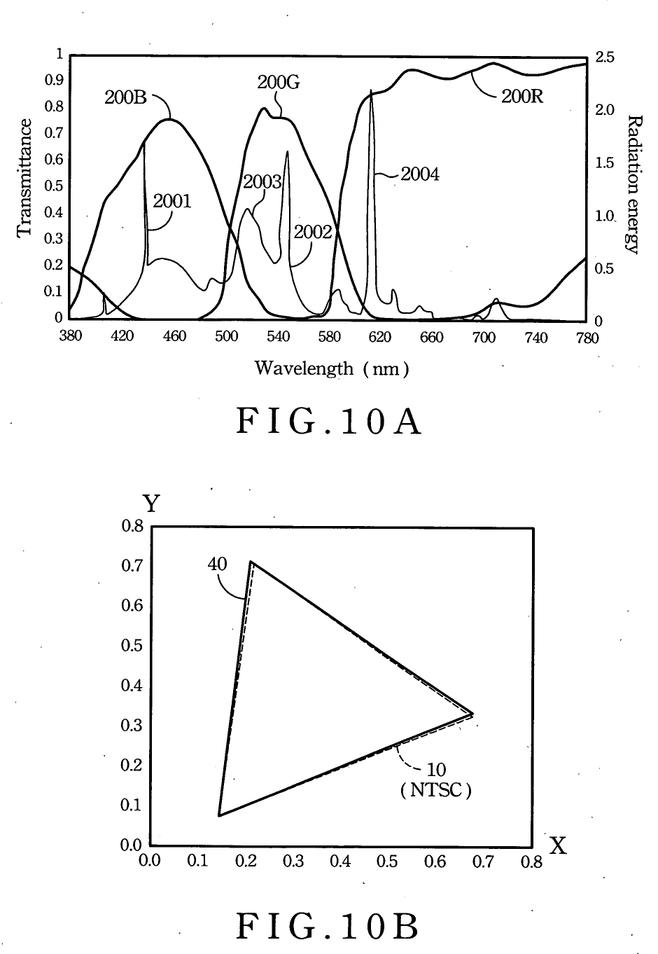

Please refer to FIG. 10A and FIG. 10B. FIG. 10A is a CIE chromaticity diagram relating to the present invention. FIG. 10B is a graph showing both the emission spectrum of a present backlight source and the spectral transmittance of a present color filter.

For the seventh embodiment, at the optical wavelength of 500 nm, the blue filter units 26B have transmittance (the blue transmittance spectrum 200B) of about 33%, and the green filter units 26G have transmittance (the green transmittance spectrum 200G) of about 33%. In addition, the intensity ratio of the second peak emission wavelength 2002 to the first peak emission wavelength 2001 is close to 1.65. The intensity ratio of the third peak emission wavelength 2003 to the first peak emission wavelength 2001 is about 1.47.

As shown in FIG. 10B, according to this embodiment, the NTSC ratio is close to 100%. The display color reproducible region 40 of the present LCD 20 overlaps the whole NTSC color reproducible region 10 on the CIE chromaticity diagram. Only the pure green of the display color reproducible region 40 exceeds the NTSC standard. However, it does not cause color distortion.

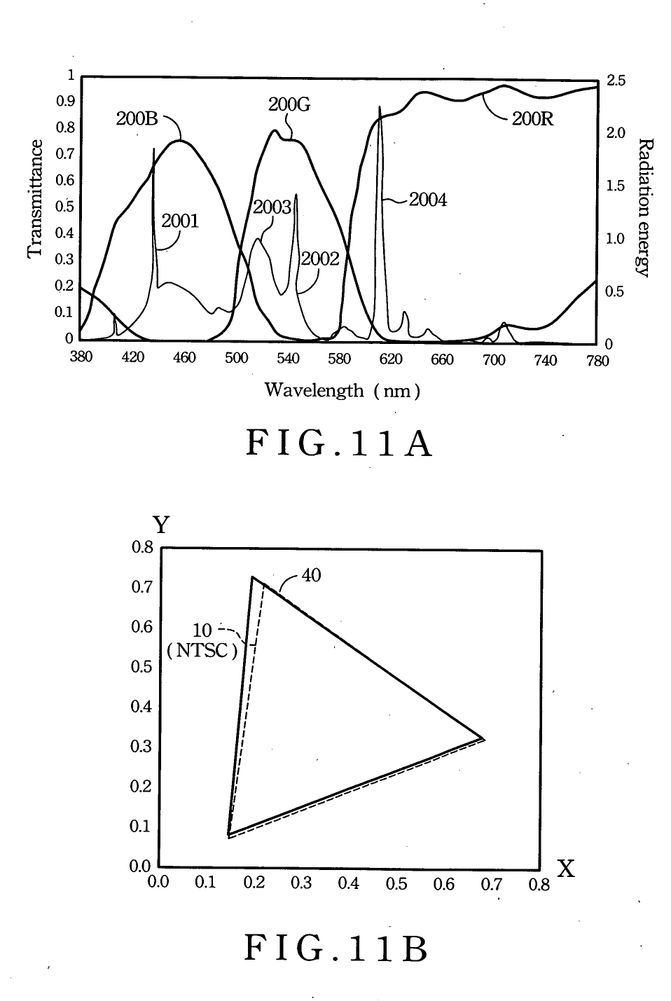

Please refer to FIG. 11A and FIG. 11B. FIG. 11A is a CIE chromaticity diagram relating to the present invention. FIG. 11B is a graph showing both the emission spectrum of a present backlight source and the spectral transmittance of a present color filter.

For this embodiment, at the optical wavelength of 500 nm, the blue filter units 26B have transmittance (the blue transmittance spectrum 200B) of about 33%, and the green filter units 26G have transmittance (the green transmittance spectrum 200G) of about 40%. In addition, the intensity ratio of the second peak emission wavelength 2002 to the first peak emission wavelength 2001 is close to 1.65. The intensity ratio of the third peak emission wavelength 2003 to the first peak emission wavelength 2001 is about 1.74.

As shown in FIG. 11B, according to this embodiment, the NTSC ratio is higher than 100%. Besides, the display color reproducible region 40 of the present LCD 20 overlaps the whole NTSC color reproducible region 10 on the CIE chromaticity diagram. Only the pure green of the display color reproducible region 40 exceeds the NTSC standard. However, it does not cause color distortion.

To sum up, according to the above embodiments and the detailed description of the present invention, the display color reproducible region of the present LCD is able to achieve a NTSC ratio of 100%. Furthermore, the NTSC ratio is higher than 100% in some embodiments. Therefore, the present LCD is able to display with high sufficient color saturation. Besides, the display color reproducible region of the present LCD is able to precisely overlap the NTSC color reproducible region. The pure red, the pure green, and the pure blue of the display color reproducible region are very close to their NTSC standard respectively. Obviously, prior drawback of color distortion and insufficient color saturation are both overcome in the present invention.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

We claim:

1. A liquid crystal display (LCD) comprising:
a color filter having a plurality of green filter units having transmittance ranging from about 0.1% to about 60% at the optical wavelength of about 500 nm, and a plurality of blue filter units having transmittance ranging from about 0.1% to about 50% at the optical wavelength of about 500 nm; and
a backlight source having a first phosphor with a first peak emission wavelength between about 446 nm and about 460 nm.

2. The liquid crystal display according to claim 1, wherein the backlight source further has a second phosphor with a second peak emission wavelength between about 540 nm and about 550 nm, the intensity ratio of the second peak emission wavelength to the first peak emission wavelength ranging from 0 to about 3.6.

3. The liquid crystal display according to claim 1, wherein the backlight source further has a third phosphor with a third peak emission wavelength between about 500 nm and about 530 nm, the intensity ratio of the third peak emission wavelength to the first peak emission wavelength ranging from about 0.8 to about 2.7.

4. The liquid crystal display according to claim 1, wherein the backlight source further has a fourth phosphor with a fourth peak emission wavelength between about 605 nm and about 615 nm.

5. The liquid crystal display according to claim 1, wherein the color filter further has a plurality of red filter units.

6. A display comprising:
a color filter having a plurality of green filter units having transmittance ranging from about 0.1% to about 60% at the optical wavelength of about 500 nm, and a plurality of blue filter units having transmittance ranging from about 0.1% to about 50% at the optical wavelength of about 500 nm; and
a light tube having a first phosphor with a first peak emission wavelength between about 440 nm and about 460 nm, a second phosphor having a second peak emission wavelength between about 540 nm and about 550 nm, and a third phosphor having a third peak emission wavelength between about 500 nm and about 530 nm,
wherein the intensity ratio of the second peak emission wavelength to the first peak emission wavelength ranges from about 0 to about 3.6, and the intensity ratio of the third peak emission wavelength to the first peak emission wavelength ranges from about 0.8 to about 2.7.

7. The display according to claim 6, wherein the backlight source further having a fourth phosphor with a fourth peak emission wavelength between about 605 nm and about 615 nm.

8. The display according to claim 6, wherein the color filter further having a plurality of red filter units.

9. A liquid crystal display comprising:
a color filter having a plurality of green filter units having the transmittance ranging from about 0.1% to about 60% at the optical wavelength of about 500 nm, and a plurality of blue filter units having the transmittance ranging from about 0.1% to about 50% at the optical wavelength of about 500 nm; and
a light tube having a first phosphor with a first peak emission wavelength between about 440 nm and about 460 nm, a second phosphor having a second peak emission wavelength between about 540 nm and about 550 nm, and a third phosphor having a third peak emission wavelength between about 500 nm and about 530 nm,
wherein the intensity ratio of the second peak emission wavelength to the first peak emission wavelength equal to or lower than 3.6, and the intensity ratio of the third peak emission wavelength to the first peak emission wavelength ranges from about 0.8 to about 2.7.

10. The display according to claim 9, wherein the backlight source further having a fourth phosphor with a fourth peak emission wavelength between about 605 nm and about 615 nm.

11. The display according to claim 9, wherein the color filter further has a plurality of red filter units.
